(19) United States
(12) Patent Application Publication
(10) Pub. No.: US 2024/0378175 A1
(43) Pub. Date: Nov. 14, 2024

(54) MULTI-CHIP SYSTOLIC ARRAYS

(71) Applicant: Etched.ai, Inc., Menlo Park, CA (US)

(72) Inventors: Gavin UBERTI, Kirkland, WA (US); Christopher ZHU, West Roxbury, MA (US)

(21) Appl. No.: 18/195,769

(22) Filed: May 10, 2023

(51) Int. Cl. G06F 15/80; G06F 17/16

(52) U.S. Cl. CPC G06F 15/8046; G06F 17/16

(57) ABSTRACT

Embodiments herein describe a combined systolic array formed by interconnecting multiple ICs (or chips) each containing individual systolic arrays. In one embodiment, the ICs are interconnected using chip-to-chip connections which couple the local systolic arrays in the ICs to each other, thereby forming a larger, combined systolic array.

### TECHNICAL FIELD

Embodiments presented in this disclosure generally relate to forming large systolic arrays from multiple chips (or integrated circuits (ICs)) containing smaller systolic arrays.

### BACKGROUND

Systolic arrays are hardware structures built for fast and efficient operation of algorithms that typically perform the same task with different data at different times. In some examples, a systolic array includes a homogeneous network of data processing units (DPUs) which each accumulate a partial result using data received from both upstream directions. Systolic arrays are often hard-wired for specific operations, such as performing massively parallel integration, convolution, correlation, matrix multiplication or data sorting tasks. Systolic arrays can also be used for dynamic programming algorithms which are often used in DNA and protein sequence analysis.

For many artificial intelligence (AI) applications (e.g., transformer models), matrix multiplications dominate the operations that must be performed in hardware. Often, the matrix multiplications can be performed very efficiently by systolic arrays. In one example, the systolic arrays include a grid of DPUs which each perform a multiply-accumulate operation (MAC) every clock cycle. However, the number of floating-point operations per second (FLOPs) that can be achieved is often dependent on the size of the systolic array, which is limited in current IC design.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a systolic array, according to one embodiment.

FIG. 2 illustrates a package with a combined systolic array formed from multiple chips, according to one embodiment.

FIG. 3 illustrates a systolic array formed from multiple chips, according to one embodiment.

FIG. 4 illustrates a systolic array formed from multiple chips, according to one embodiment.

FIG. 5, illustrates hardwiring external memory chips to chips containing systolic arrays, according to one embodiment.

FIG. 6 illustrates connecting chips containing systolic arrays to local memory chips, according to one embodiment.

FIG. 7 illustrates pipelining a combined systolic array, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### SUMMARY

Embodiments presented in this disclosure is a package that includes a plurality of integrated circuits (ICs), each comprising a local systolic array of data processing units (DPUs) and chip-to-chip connections configured to connect the local systolic array in each of the plurality of ICs to at least one other local systolic array in another one of the plurality of ICs to form a larger, combined systolic array.

Another embodiment in this disclosure is an AI accelerator that includes a plurality of integrated circuits (ICs) each comprising a local systolic array of DPUs; chip-to-chip connections configured to connect the local systolic arrays to form a larger, combined systolic array; and a plurality of memory chips configured to store weights for performing matrix multiplications in the combined systolic array as part of an AI model, the plurality of memory chips coupled to the plurality of ICs forming a top row of the combined systolic array.

Another embodiment in this disclosure is a package that includes a plurality of integrated circuits (ICs), each comprising a local systolic array of data processing units (DPUs) where the plurality of ICs are arranged in a grid-like pattern and the local systolic arrays are connected to form a larger, combined systolic array.

Another embodiment in this disclosure is a package that includes an IC comprising a systolic array of data processing units (DPUs) and a separate memory device comprising a plurality of channels where each of the plurality of channels is hardwired to respective one or more columns in the systolic array without any switching element.

### DETAILED DESCRIPTION

Embodiments herein describe a combined systolic array formed by interconnecting multiple ICs (or chips) each containing individual systolic arrays. A systolic array is well suited for high-throughput matrix multiplication due to how well it scales. Rather than a general-purpose ALU (arithmetic logic unit) which may require several load/store sequences to compute a single matrix product, a systolic array can load all values at once and perform a matrix product with no idle clock cycles for waiting to store intermediate values in registers to memory.

Large systolic arrays are also efficient with respect to input/output bandwidth. For example, an N×N systolic array computes 2N\hat{ } 2 FLOPs per clock cycle, while only requiring 2N input values per clock cycle. Many artificial intelligence (AI) accelerators have adopted a systolic array architecture for computational efficiency and density, but the sizes of these arrays are limited. Currently, most chips have, at most, floating point systolic arrays with a size of 128×128. While such a systolic array could theoretically provide sufficient compute power in terms of available FLOPs, it presents several issues. One of which, notably, is that it is unreasonable to expect a single chip to interface with 100s of GB of memory used to store parameters and intermediate computation values.

Instead, the embodiments herein adapt a multi-chip approach where multiple local systolic arrays on multiple chips (or ICs) are connected using high-speed chip-to-chip connections to form a larger, combined systolic array. This array can be formed in a package that interfaces with a host computer. While the embodiments herein primarily discuss forming large systolic arrays for AI applications (e.g., AI accelerators), they are not limited to such and can be used for other applications (e.g., cryptography, DNA and protein sequencing, digital signal processing, and the like).

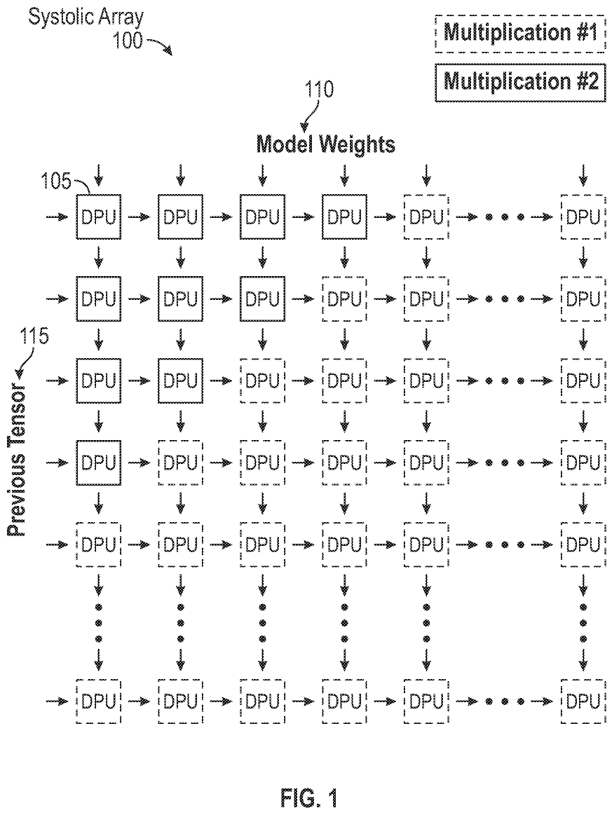

FIG. 1 illustrates a systolic array 100, according to one embodiment. In this example, the systolic array 100 includes a grid of DPUs 105 arranged in rows and columns. In this embodiment, the DPUs 105 perform a MAC operation, but are not limited to such.

The arrows in FIG. 1 illustrate the flow of data between the DPUs 105. Further, FIG. 1 illustrates using the systolic array 100 for matrix multiplication in running an AI model where the DPUs in the leftmost column receive a tensor 115, which can be a previous tensor 115 calculated by the systolic array 100. The topmost row of DPUs 105 receive AI model weights 110, which may be constants. Except for the leftmost column and the topmost row, the rest of the DPUs 105 receive an input from two of its neighbors (e.g., the left DPU and the top DPU).

After performing the MAC operation using the inputs, the DPU 105 passes those same inputs to its rightmost neighboring DPU 105 and the DPU 105 located beneath it. That is, in one embodiment, the weight and tensor data may pass between the rows and columns without being changed by the DPUs 105. In this manner, the data from the previous tensor 115 (e.g., the previous layer) flows from left to right while the model weights 110 flow from top to bottom.

In one embodiment, each DPU 105 performs an operation to generate partial results each clock cycle. That is, the DPU 105 can receive two new inputs and generate a new partial result each clock cycle. In one embodiment, each of the DPUs 105 add this result to an internal accumulator. Once the DPU has seen the entire tensor and weight values, the value stored in its accumulator is output as the computed answer.

FIG. 1 also illustrates that the systolic array 100 can perform two different computations in parallel. That is, the DPUs 105 with hashing illustrate performing a first computation while the DPUs 105 without hashing perform a second computation. For example, the hashed DPUs 105 can perform a matrix multiplication corresponding to a first weight matrix while the non-hashed DPUs 105 can perform a matrix multiplication corresponding to a second weight matrix. In this manner, the systolic array 100 can perform different operations for a single layer in an AI model, or perform operations for different layers in the AI model, simultaneously. Furthermore, the DPUs 105 in the systolic array 100 can be distributed across multiple chips (ICs), which is discussed in more detail in the following figures.

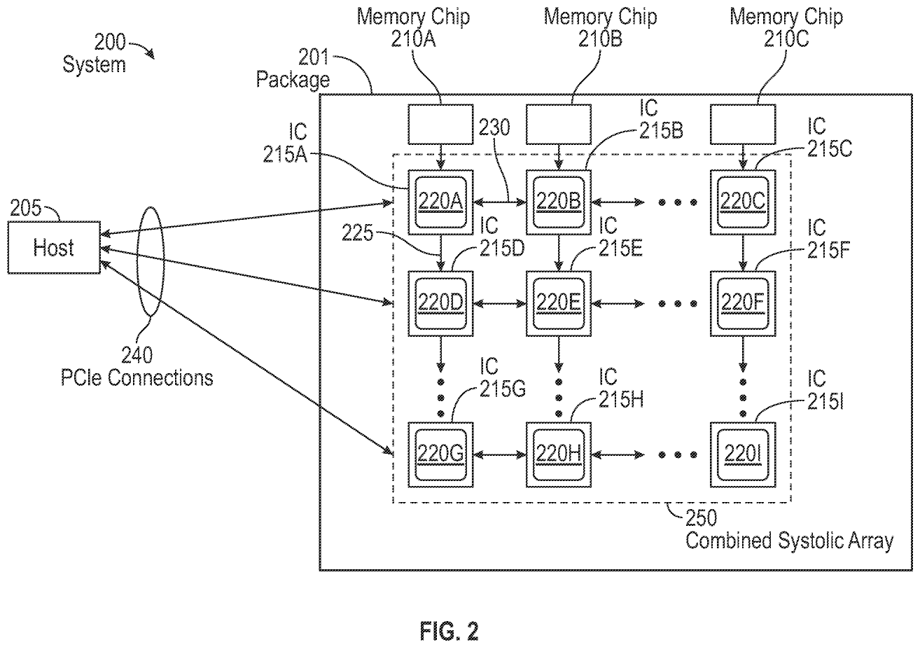

FIG. 2 illustrates a package 201 with a combined systolic array 250 formed from multiple chips, according to one embodiment. In this example, the package 201 is coupled to a host 205 which can be a computing device (e.g., a server) or multiple computing devices. For example, the system 200 may be deployed in a cloud computing data center with multiple hosts 205 (e.g., multiple computing devices) and multiple instances of the package 201. In one embodiment, the host 205 and the package 201 are disposed in the same form factor, but this is not a requirement.

Although not shown, the host 205 can include multiple processors (e.g., central processing units (CPUs) and memory. For example, the host 205 may execute an operating system that communicates with the package 201 using the PCIe connections 240. In one embodiment, the package 201 may be an accelerator such as a machine learning (ML)/AI accelerator, crypto-accelerator, digital signal processing accelerator, and the like. In general, the package 201 can be used to accelerate any function that uses a systolic array 250 to perform computations. In one embodiment, the host 205 executes a software program that offloads tasks to the package 201 and receives the results from executing those tasks on the systolic array 250. In one embodiment, the host 205 can communicate with (e.g., offload task to) multiple, different AI accelerators which may be optimized for different AI models.

The host 205 can use the PCIe connections 240 (or any other suitable interconnect) to transmit data to, and receive data from, the systolic array 250. In this example, the PCIe connections 240 are used to transmit data to the leftmost column of ICs 215 (or chips) in the package 201. The PCIe connections 240 may be used to start a task for an application (e.g., an AI application) executing on the host 205. When the package 201 is used as an AI accelerator for a language model, an application on the host 205 can submit an embedding vector corresponding to a token (e.g., a group of characters, an embedding of an image, or metadata) to the leftmost column of ICs 215. While the PCIe connections 240 can be used to load data into the systolic array 250, in one embodiment, the systolic array 250 does not take instructions at runtime, and only executes instructions in a preset loop.

In this example, the package 201 includes a grid of ICs 215 that each include a local systolic array 220. That is, each IC 215 includes a smaller portion of the combined systolic array 250. Thus, while FIG. 2 illustrates a physical layout of the combined systolic array 250 where the array 250 is distributed across multiple ICs 215, a logical view of the array 250 can be represented by the array 100 in FIG. 1. For example, from the perspective of the host 205, the systolic array 250 appears to be one large array, even though it is physically made up of smaller local systolic arrays 220 distributed on separate ICs 215. In one embodiment, the ICs 215 are all identical.

The ICs 215 are connected to neighboring ICs 215 using chip-to-chip connections. In this example, the package 201 includes two types of chip-to-chip connections: horizontal chip-to-chip connections 230 and vertical chip-to-chip connections 225. In one embodiment, the horizontal connections 230 are bidirectional which permits data to flow from left to right and from right to left, while the vertical connections 225 are unidirectional which permits data to flow only from top to bottom (not from bottom to top).

The chip-to-chip connections 225 and 230 are not limited to any particular type of connection, so long as the connection permits the flow of data between the local systolic arrays 220 so that the DPUs can output data each clock cycle. In one embodiment, Universal Chiplet Interconnect Express (UCIe) can be used to form the chip-to-chip (or die-to-die) connections 225 and 230, which has a physical layer that supports up to 32 GT/s with 16 to 64 lanes.

In one embodiment, the package 201 may include an silicon wafer interposer or conventional PCB substrate on which the ICs 215 are disposed in grid-like pattern. The chip-to-chip connections 225 and 230 may be formed in the interposer. However, in another embodiment, the ICs 215 may be formed in a stack, rather than being disposed side-by-side as shown in FIG. 2. For example, the systolic array 250 may include just one row of the ICs 215 where the ICs 215 are stacked on top of each other. Micro bumps or copper pillars can be used to form the chip-to-chip connections directly between the ICs 215 in the stack to form a combined systolic array from the local systolic arrays 220 in each of the ICs 215.

In one embodiment, the bandwidth of the connection of the horizontal chip-to-chip connections 230 is different for data flowing from left to right relative to data flowing from right to left. In one example, the connections 230 may provide much higher data rates for data moving from left to right than the data rates for transferring data right to left. For example, the systolic array 250 may use the right to left bandwidth to return results generated by the ICs 215 in the rightmost column back to the inputs of the systolic array 250 at the ICs 215 in the leftmost column. As a non-limiting example, the left-to-right data paths in the horizontal connections 230 may support data streams of hundreds of GBs, while the right-to-left data paths in the horizontal connections 230 may support data streams of tens of GBs (or less). Furthermore, the left-to-right data paths in the horizontal connections 230 may have a fairly constant utilization while the right-to-left data paths may be bursty (e.g., used when the computation for a row vector has been completed and the resultant values are being fed back to the leftmost input column of ICs 215).

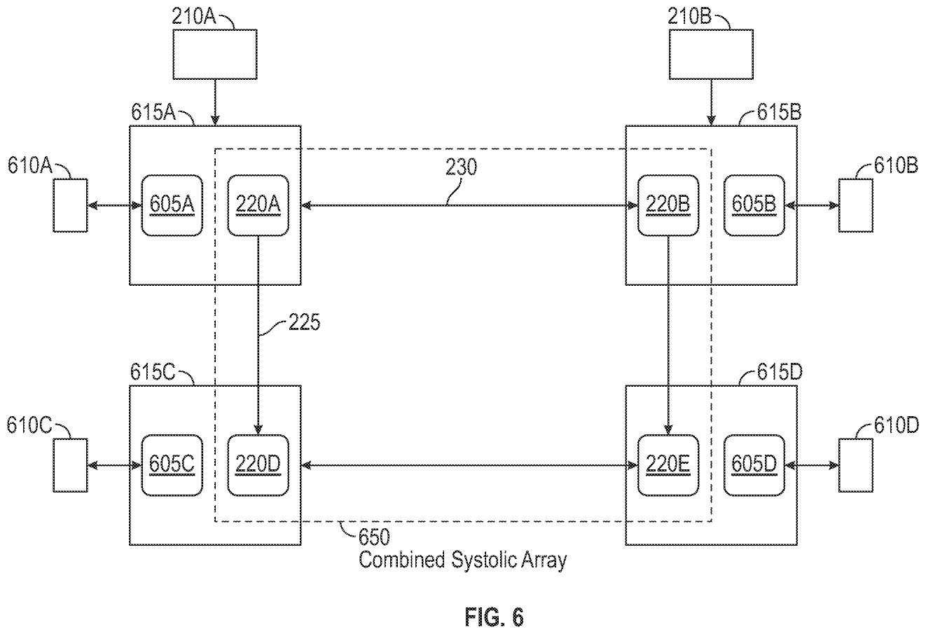

The size of the local systolic arrays 220 can vary. For example, the arrays 220 can have sizes of approximately 100-10000 rows and 100-10000 columns of DPUs. However, this can vary depending on the overall physical size of the ICs 215, the process node used to fabricate the ICs 215 (e.g., 7 nm, 10 nm, 14 nm, 22 nm, 32 nm, etc.) and the other circuitry in the ICs 215 beside the local systolic arrays 220. For example, in some embodiments, the ICs 215 may include other circuitry besides the local systolic arrays 220 and input/output (I/O) circuitry. This is discussed in more detail in FIG. 6 below.

In addition to the ICs 215, the package 201 includes memory chips 210. The memory chips 210 are connected to the ICs 215 using the vertical chip-to-chip connections 225. In this example, the connections 225 between the memory chips 210 and the ICs 215 are unidirectional, where the ICs 215 can only read data from the memory chips 210, but do not write data to the memory chips 210. However, in other accelerator applications, it may be advantageous to have bidirectional connections between the ICs 215 and the memory chips 210 so that the ICs 215 can write to the memory chips 210.

In one embodiment, the memory chips 210 are High Bandwidth Memories (HBMs), but this is not a requirement. If the systolic array 250 is used in an AI accelerator application, the memory chips 210 can store the weights for the AI model being used at runtime. The weights can be provided by the memory chips 210 to the top row of the ICs 215 where the weights are passed down through the local systolic arrays 220 and to the remaining rows of ICs 215 using the vertical chip-to-chip connections 225. In one embodiment, the weights are constant when executing the combined systolic array 250. Nonetheless, although not shown, the package may include additional PCIe connections between the memory chips 210 and the host 205 so that an application on the host 205 can update the data (e.g., weights) stored in the memory chips 210. Although FIG. 2 illustrates connecting one memory chip 210 to each of the ICs 215 in the top row, multiple memory chips 210 can be connected to the ICs 215.

In one embodiment, the memory chips 210 can be connected to the ICs 215 through a substrate, such as an interposer. Alternatively, the memory chips 210 can be stacked directly on the ICs 215. For example, HBMs are themselves a stack of DRAM dies with an optional base die. The DRAM dies in the HBMs can be interconnected by through-silicon vias (TSVs) and microbumps. The HBMs can be disposed on the ICs 215 directly and connect to the IC 215 using microbumps.

Further, in some embodiments, the memory chips 210 may not be needed. That is, some packages may not include any memory chips 210. Instead, the host 205 can provide the input data for both the X direction (e.g., by providing data to the leftmost column of ICs 215) and the Y direction (e.g., by providing data to the topmost row of ICs 215) using the PCIe connections 240.

As discussed in more detail below, the package 201 can include any number of the ICs 215, which can have any number of rows and columns. For example, the combined systolic array 250 may be formed from a single row of ICs 215, or from a single column of ICs 215. In that case, assuming each IC 215 has a local systolic array 220 of dimensions 100×100 (measured in terms of DPUs within the systolic arrays 220), a single row of four ICs 215 would form a 100×400 combined systolic array 250 while a single column of four ICs 215 would form a 400×100 combined systolic array 250. Different packages 201 may have different sizes of systolic arrays 250 depending on their applications (e.g., depending on the type of computation being performed). Moreover, the physical limitations of current packaging techniques and IC technology may limit the number of ICs 215 that can be disposed in the same package 201.

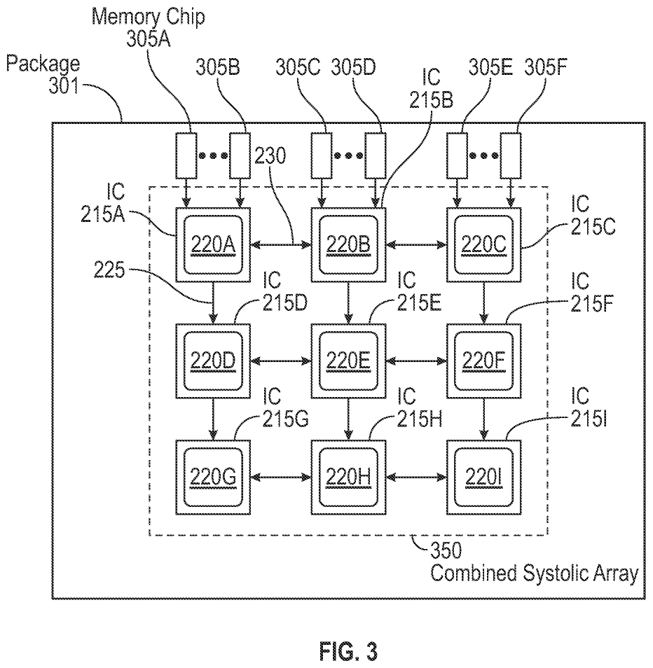

FIG. 3 illustrates a combined systolic array 350 formed from multiple chips, according to one embodiment. That is, FIG. 3 illustrates a package 301 that includes a square systolic array 350. That is, the systolic array 350 has the same number of rows and columns, with the same number of ICs 215 in each row and column. Advantageously, adding more rows of ICs 215 increases the compute power of the systolic array 350, without having to add more memory chips 305 at the top to feed in data in the vertical direction, since data fed from the memory chips 305 is reused across the rows within the combined systolic array 350. Thus, adding a fourth or fifth row of ICs 215 to the systolic array 350 does not require adding more memory chips 305. As discussed above, the number of rows and columns of ICs 215 that can be added in the package 301 may be limited by packaging techniques.

FIG. 3 also illustrates coupling multiple memory chips 305 to one IC 215 in the top row of the array 350. For AI applications, one HBM memory chip 305 may not be sufficient to provide weight data fast enough for the local systolic arrays 220. As such, multiple memory chips 305 can be attached to the ICs 215 to provide higher combined bandwidth. For example, three memory chips 305 can be attached to each IC 215 in the top row of the combined systolic array 350, where each of the memory chips 305 provides weight data to a respective third of the columns in the local systolic arrays 220. In one embodiment, using multiple memory chips 305 can enable the memory chips 305 to transmit more than 1 TB/s of data to each of the ICs 215 in the topmost row, and this data can be forwarded to ICs 215 in lower rows via the vertical connections 225.

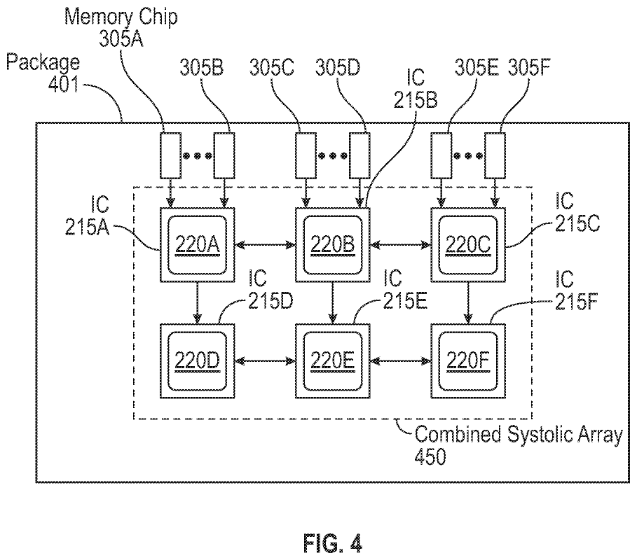

FIG. 4 illustrates a systolic array 450 formed from multiple chips, according to one embodiment. In contrast to FIG. 3, the combined systolic array 450 in FIG. 4 has an unequal number of rows and columns. For example, due to physical limitations, the package 401 may be able to only have two rows of ICs 215 rather than the three rows shown in FIG. 3. However, FIGS. 3 and 4 illustrate that combined systolic arrays can be formed using an equal number of rows and columns of ICs 215, or from unequal rows and columns of ICs 215.

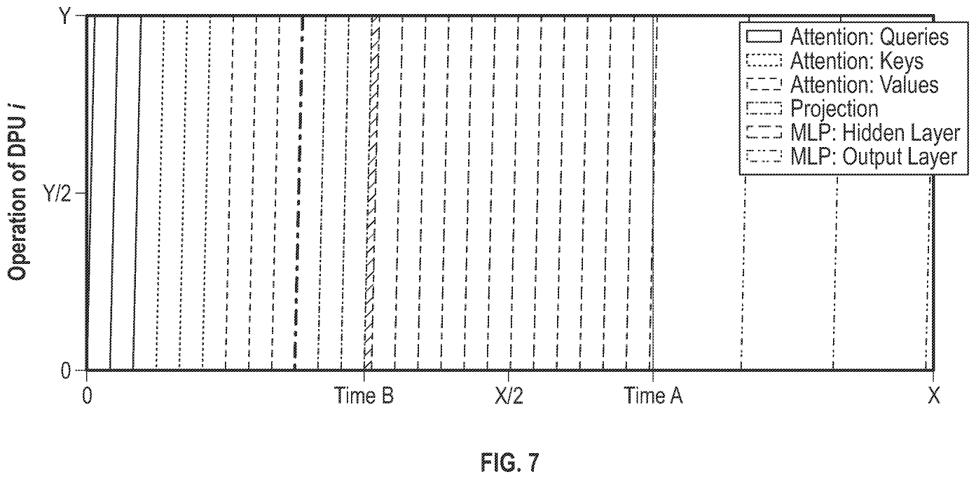

Despite having three columns and two rows, the combined systolic array 450 can function in essentially the same manner as a systolic array with equal numbers of rows and columns. In one embodiment, the rows of the systolic array do not cross. That is, results are computed in each row of DPUs within the systolic arrays 220 of the ICs 215 independently from the other rows of such DPUs in the systolic arrays, whereby a combined row of such DPUs across a row of ICs 215 forms a “row” of DPUs within the combined systolic array 450. As such, even if the combined systolic array 450 does not have sufficient number of rows to process an input, the operation can be repeated. For example, assume that a particular operation provides an input row vector that has 600 entries, but the combined systolic array 450 only has 300 columns (e.g., each local systolic array 220 has 100 columns). The combined systolic array 450 may process the first 300 entries of the input row vector (fed into the combined systolic array 450 starting from the left) during a first pass and then process the next 300 entries in a second pass. Handling mismatch between the dimensions of the systolic array and the dimensions of input data or the desired dimensions of the output data is described in more detail in FIG. 7 below.

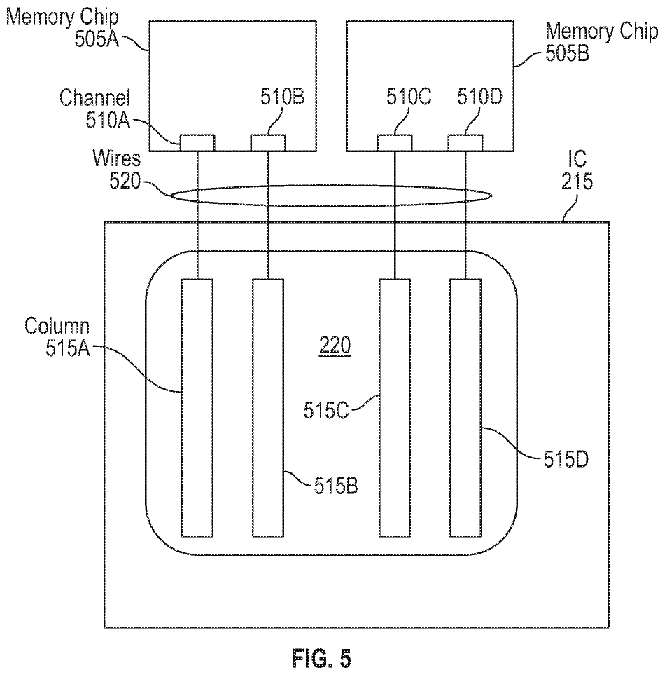

FIG. 5 illustrates hardwiring external memory chips to chips containing systolic arrays, according to one embodiment. As shown, FIG. 5 includes memory chips 505 that are hardwired using the wires 520 (e.g., without a switch or switching element) to the IC 215. In this example, the memory chips 505 have separate independent channels 510. For example, in HBM, the different channels 510 cannot communicate with each other. As such, if a device coupled to the HBM wants to access memory assigned to different channels 510, a switch (or some kind of switching element such as a crossbar) is typically used so that the device can access the entire memory of the HBM.

However, for some accelerator applications such as AI applications where the weight data does not change, the independent channels 510 can be directly wired (or hardwired) to a particular column 515 in the local systolic array 220 of the IC 215. This systolic array column could extend through all the ICs 215 in a column. For example, for some matrix multiplications, the same weights are provided to the same columns. As such, the columns 515 of DPUs in the local systolic array 220 can be hardwired to a particular channel 510 of the memory chip 505 (e.g., a HBM chip). As shown in FIG. 5, the column 515A of the array 220 is connected by one or more wires 520 to the channel 510A in memory chip 505A, the column 515B is hardwired to the channel 510B in memory chip 505A, the column 515C is hardwired to the channel 510C in memory chip 505B, and the column 515D is hardwired to the channel 510D in memory chip 505B.

Because the column 515A of DPUs is hardwired to the channel 510A, this column may be unable to read data in the memory chip 505A assigned to the channel 510B. The reverse is true for the column 515B of DPUs where it can read the data from the memory locations in the memory chip 505A assigned to the channel 510B but not the memory locations assigned to the channel 510A. However, since the memory chips 505 may be used to store constant weight data that is always provided to the same columns 515, hardwiring the memory chips 505 to the columns 515 is permissible. This avoids having to add a switching element between the local systolic array 220 and the memory chips 505, which can save space and power.

FIG. 6 illustrates connecting chips containing systolic arrays to local memory chips, according to one embodiment. Like the embodiments above, FIG. 6 illustrates using multiple ICs 615, each having local systolic arrays 220, to form a larger, combined systolic array 650. That is, the local systolic arrays 220 can be interconnected using horizontal and vertical chip-to-chip connections 225 and 230. Further, the top row of the ICs 615 can be connected to memory chips 210. While FIG. 6 illustrates connecting the ICs 615 in the top row to one memory chip 210, they can be connected to any number of memory chips 210 as shown in FIGS. 3 and 4.

In addition, the ICs 615 include auxiliary circuitry 605 which is separate from the local systolic arrays 220. That is, FIG. 6 illustrates that the ICs 615 can include other circuitry besides the systolic arrays 220. In one embodiment, the auxiliary circuitry 605 may be specialized circuitry to perform accelerator functions that are not efficiently performed by the systolic array. As a non-limiting example, for AI accelerators, self-attention operations use data computed from previous tokens, which means such data should be saved. Most of the parts of a transformer AI model do not use data from previous tokens, and thus, can be calculated efficiently using the combined systolic array 650 which may consider each token in isolation from the other tokens being computed on. However, for operations that do use previous data computed from previous tokens in a sequence, these operations can be delegated to the auxiliary circuitry 605. For example, self-attention operations may require each row to be multiplied by a different matrix where the other matrix is determined by data computed from previous tokens.

As shown, the auxiliary circuitry 605 in each IC 615 is coupled to at least one local memory chip 610 (e.g., one or more HBMs). In other examples, the auxiliary circuitry 605 in each of the ICs 615 can be coupled to as many local memories 610 as needed to complete the specific operation, or is permitted by packaging techniques. Because there are many different types of self-attention algorithms, each with their own memory capacity and bandwidth requirements, attaching the auxiliary circuitry 605 to as many local memory chips 610 as possible can enable the accelerator device to support a greater number of such algorithms.

For example, four local memory chips 610 could be disposed around each IC 615—e.g., two memory chips 610 on opposite sides, or one memory chip 610 disposed on each side. Further, in one embodiment, the ICs 615 may be attached to the same number of local memory chips 610. However, in other embodiments, the ICs 615 may be coupled to different number of local memory chips 610. For example, the ICs 615 in the top row may be coupled to fewer local memory chips 610 than the lower rows since they are already coupled to the memory chips 210, which provide input into the combined systolic array 650.

The auxiliary circuitry 605 is not limited to any particular type of circuit. Indeed, the function of the auxiliary circuitry 605 may change depending on the type of acceleration being performed by the accelerator device (e.g., AI acceleration, crypto acceleration, DNA and protein sequencing, signal processing, etc.). The auxiliary circuitry 605 could be a separate systolic array (which has access to the local memory chips 610), or could be a different type of processing element (e.g., a micro-processor, a controller, an arithmetic-logic unit (ALU), and the like).

In this embodiment, the local systolic arrays 220 do not have access to the local memory chips 610. That is, in this example, only the auxiliary circuitry 605 can access the local memory chips 610. However, in other examples, the local systolic arrays 220 may also have access to the memory chips 610. For instance, instead of (or in addition to) using local SRAM on the ICs 615, the local systolic arrays 220 may use the memory chips 610 as scratchpad space when performing their operations.

In this embodiment, the auxiliary circuitry 605 in one IC 615 cannot directly communicate with the auxiliary circuitry 605 in another IC 615. For example, the auxiliary circuitry 605 in each IC 615 may operate independently of each other. Instead, the auxiliary circuitry 605 in each IC 615 may interface with the local systolic array 220 on the same IC 615 in order to pass data and results to each other. Alternatively, in another embodiment, the auxiliary circuitry 605 in the ICs 615 may be interconnected to each other using the horizontal and vertical chip-to-chip connections 225, 230 in a same or similar way as the local systolic arrays 220 are interconnected to form the combined systolic array 650.

FIG. 7 illustrates pipelining a combined systolic array, according to one embodiment, in the context of running a transformer AI model. Specifically, FIG. 7 illustrates the contents of one row of the combined systolic array while computing the output for one layer of the AI model. The X axis indicates the total number of clock cycles used to compute an output for one of the layers in the AI model while the Y axis indicates the number of DPUs in the row. As such, FIG. 7 illustrates what each DPU in the row of the systolic array is processing during each clock cycle.

The slanted, black lines indicate that the DPU produces an output during that cycle. The blank lines are slanted due to the Y number of cycles it takes data to propagate across each row of the systolic array, since data is transferred sequentially across consecutive DPUs each clock cycle. The bold dashed line indicates a swap between the two sequences currently being computed by the IC containing the systolic array. In this scenario, the IC contains both a systolic array and an auxiliary computation unit (e.g., the auxiliary circuitry 605 in FIG. 6), and these two sections of the chip interchange data on a periodic basis. Each of the two sections of the chip computes values for its own sequence of data, handing off values to the other section to perform computations that it itself is not capable of performing (or may not be efficient at doing).

FIG. 7 also illustrates that the dimensions of the systolic array may not be large enough to perform one operation during a single pass through the array. In response, input tensors may be divided up and processed in multiple batches. For example, the output of an operation may be a square matrix, but the systolic array may be smaller in at least one dimension. As such, multiple batches may be used to calculate the desired output matrix for the operation. For example, to calculate the query values (e.g., perform the “Attention: queries” computation) used in the attention mechanism of transformer AI models, the data passes through the systolic array three times. For example, the input tensor for calculating the query values may be divided into three portions, where the portions are inputted into the systolic array in three batches. This is the same for performing the “Attention: keys”, “Attention: values”, and “Projection” operations, which also appear in the example of running a transformer AI model. Continuing this example, the hidden and output layers for multi-layer perceptron (MLP)—a portion of a transformer which performs non-linear transformations on the input embeddings—operations may also use multiple batches or passes to calculate the outputs.

To achieve 100% efficiency (or close to 100% efficiency), the inputs for the subsequent computation are fed into the systolic array before the previous computation completes. For example, at Time A, the leftmost DPU in the row (e.g., DPU 0) is performing the computation associated with the output layer of the MLP, while the rightmost DPU in the row (e.g., DPU Y) is still working on the previous computation, the MLP hidden layer. When switching from the hidden layer to the output layer of the MLP, post-processing work (e.g., residual addition, GeLU, etc.) may be performed. That is, post processing may be performed before the inputs are moved from the rightmost chips in the systolic array to be re-fed into the leftmost chips in the systolic array. To prevent a stall, this post-processing can be performed on the values that have already been generated (e.g., compute a GeLU for every value) and fed back into the input to start a new computation while the previous computation is still occurring. In this manner, when there is data dependency between different operations in a sequence, post-processing can still be performed and the data fed back to the inputs of the systolic array without causing a delay.

However, in some situations, a stall may occur. For most post-processing operations such as scaling, biasing, residual connections, and GeLU, these operations can be performed before an entire row vector has computed by the systolic array, as they are elementwise (broadcast) operations. This permits the accelerator to begin feeding the output layer of the MLP model before fully computing the hidden layer of the MLP. Layer normalization is different, however. It may require scaling based on the mean and variance of the row vector, which cannot be known until the entire input row vector is known. This means the systolic array may stall during layer normalization. This is shown at Time B where the array stalls for the amount of clock cycles that equals the number of DPUs in the row (i.e., X number of clock cycles). The array may stall for some additional clock cycles to provide time to feed the mean and variance values to the input of the systolic array. In any case, the stalled time may be small relative to the computation time and still result in a 98% or greater utilization of the systolic array.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A package, comprising:
a plurality of integrated circuits (ICs), each comprising a local systolic array of data processing units (DPUs); and
chip-to-chip connections configured to connect the local systolic array in each of the plurality of ICs to at least one other local systolic array in another one of the plurality of ICs to form a larger, combined systolic array.

2. The package of claim 1, wherein the chip-to-chip connections comprise:
horizontal chip-to-chip connections that connect the local systolic arrays to form a row of the combined systolic array; or
vertical chip-to-chip connections that connect the local systolic arrays to form a column of the combined systolic array.

3. The package of claim 2, wherein the horizontal chip-to-chip connections are bidirectional to permit a rightmost IC within a row of the plurality of ICs in the combined systolic array to feed back data to a leftmost IC within the row.

4. The package of claim 2, wherein the vertical chip-to-chip connections are unidirectional such that data can flow only from a topmost row of the plurality of ICs in the combined systolic array to a bottom most row of the plurality of ICs in the combined systolic array.

5. The package of claim 3, further comprising:
a plurality of memory chips, wherein at least one of the plurality of memory chips is connected to each one of the plurality of ICs in a topmost row.

6. The package of claim 5, wherein the plurality of memory chips are configured to store weight data for performing a matrix multiplication in the systolic array for an artificial intelligence (AI) model.

7. The package of claim 5, wherein the plurality of memory chips are high-bandwidth memories (HBMs), wherein the HBMs are hardwired to respective columns in the local systolic arrays without any switching element.

8. The package of claim 7, wherein multiple HBMs are hardwired to each of the plurality of ICs in the topmost row.

9. The package of claim 1, further comprising:
an interposer, wherein the plurality of ICs are disposed in a grid pattern on the interposer, wherein the chip-to-chip connections extend through the interposer.

10. The package of claim 1, wherein the plurality of ICs are stacked on each other, wherein the chip-to-chip connections are formed using microbumps or pillars connecting the plurality of ICs.

11. The package of claim 1, wherein each of the plurality of ICs comprises auxiliary circuitry separate from the local systolic array, wherein the package further comprises:
local memory chips coupled to the auxiliary circuitry in each of the plurality of ICs.

12. The package of claim 11, wherein the auxiliary circuitry is configured to perform self-attention operations that use data from previous tokens that is stored in the local memory chips, wherein the self-attention operations are part of an AI model.

13. The package of claim 12, wherein the local systolic arrays do not communicate with the local memory chips.

14. The package of claim 1, further comprising:
at least one memory chip connected to a topmost IC of the plurality of ICs, wherein the plurality of ICs form a single column.

15. An AI accelerator, comprising:
a plurality of integrated circuits (ICs), each comprising a local systolic array of DPUs;
chip-to-chip connections configured to connect the local systolic arrays to form a larger, combined systolic array; and
a plurality of memory chips configured to store weights for performing matrix multiplications in the combined systolic array as part of an AI model, the plurality of memory chips coupled to the plurality of ICs forming a top row of the combined systolic array.

16. The AI accelerator of claim 15, wherein the chip-to-chip connections comprise:
horizontal chip-to-chip connections that connect the local systolic arrays to form a row of the combined systolic array; or
vertical chip-to-chip connections that connect the local systolic arrays to form a column of the combined systolic array.

17. The AI accelerator of claim 16, wherein the horizontal chip-to-chip connections are bidirectional to permit a rightmost IC within a row of the plurality of ICs in the combined systolic array to feed back data to a leftmost IC within the row.

18. The AI accelerator of claim 16, wherein the vertical chip-to-chip connections are unidirectional such that data can flow only from a topmost row of the plurality of ICs in the combined systolic array to a bottom most row of the plurality of ICs in the combined systolic array.

19. The AI accelerator of claim 15, wherein the plurality of memory chips are high-bandwidth memories (HBMs), wherein the HBMs are hardwired to respective columns in the local systolic arrays without any switching element.

20. The AI accelerator of claim 19, wherein multiple HBMs are hardwired to each of the plurality of ICs in the top row.

21. The AI accelerator of claim 15, further comprising:
an interposer, wherein the plurality of ICs are disposed in a grid pattern on the interposer, wherein the chip-to-chip connections extend through the interposer.

22. The AI accelerator of claim 15, wherein the plurality of ICs are stacked on each other, wherein the chip-to-chip connections are formed using microbumps or pillars connecting the plurality of ICs.

23. The AI accelerator of claim 15, wherein each of the plurality of ICs comprises auxiliary circuitry separate from the local systolic array, wherein the AI accelerator further comprises:
local memory chips coupled to the auxiliary circuitry in each of the plurality of ICs.

24. The AI accelerator of claim 23, wherein the auxiliary circuitry is configured to perform self-attention operations that use data from previous tokens that is stored in the local memory chips, wherein the self-attention operations are part of the AI model.

25. The AI accelerator of claim 23, wherein the local systolic arrays do not communicate with the local memory chips.

26. A package, comprising:
a plurality of integrated circuits (ICs), each comprising a local systolic array of data processing units (DPUs), wherein the plurality of ICs are arranged in a grid-like pattern,
wherein the local systolic arrays are connected to form a larger, combined systolic array.

27. The package of claim 26, wherein the local systolic arrays are connected by:
horizontal chip-to-chip connections that connect the local systolic arrays to form a row of the combined systolic array; or
vertical chip-to-chip connections that connect the local systolic arrays to form a column of the combined systolic array.

28. The package of claim 27, wherein the horizontal chip-to-chip connections are bidirectional to permit a rightmost IC within a row of the plurality of ICs in the combined systolic array to feed back data to a leftmost IC within the row.

29. The package of claim 27, wherein the vertical chip-to-chip connections are unidirectional such that data can flow only from a topmost row of the plurality of ICs in the combined systolic array to a bottom most row of the plurality of ICs in the combined systolic array.

30. The package of claim 28, further comprising:
a plurality of memory chips, wherein at least one of the plurality of memory chips is connected to each one of the plurality of ICs in a topmost row.

31. The package of claim 30, wherein the plurality of memory chips are configured to store weight data for performing a matrix multiplication in the systolic array for an AI model.

32. The package of claim 30, wherein the plurality of memory chips are high-bandwidth memories (HBMs), wherein the HBMs are hardwired to respective columns in the local systolic arrays without any switching element.

33. The package of claim 32, wherein multiple HBMs are hardwired to each of the plurality of ICs in the topmost row.

34. The package of claim 26, further comprising:
an interposer, wherein the plurality of ICs are disposed in a grid pattern on the interposer.

35. The package of claim 26, wherein the plurality of ICs are stacked on each other, wherein the local systolic arrays are connected using microbumps or pillars connecting the plurality of ICs.

36. The package of claim 26, wherein each of the plurality of ICs comprises auxiliary circuitry separate from the local systolic array, wherein the package further comprises:
local memory chips coupled to the auxiliary circuitry in each of the plurality of ICs.

37. The package of claim 36, wherein the auxiliary circuitry is configured to perform self-attention operations that use data from previous tokens that is stored in the local memory chips, wherein the self-attention operations are part of an AI model.

38. The package of claim 37, wherein the local systolic arrays do not communicate with the local memory chips.

39. A package, comprising:
an IC comprising a systolic array of data processing units (DPUs); and
a separate memory device comprising a plurality of channels, wherein each of the plurality of channels is hardwired to respective one or more columns in the systolic array without any switching element.

40. The package of claim 39, wherein the memory device is configured to store weight data for performing a matrix multiplication in the systolic array for an artificial intelligence (AI) model.

41. The package of claim 39, wherein the memory device is a high-bandwidth memory (HBM).

42. The package of claim 39, further comprising:
a plurality of memory devices coupled to the IC, wherein each of the plurality of memory devices comprises a plurality of channels, wherein each of the plurality of channels is hardwire to respective one or more columns in the systolic array without any switching element.
